(19) United States
(12) Patent Application Publication
(10) Pub. No.: US 2007/0090045 A1
(43) Pub. Date: Apr. 26, 2007

(54) Multidiameter wire cloth

(76) Inventor: John James Bakula, Grand Island, NY (US)

Correspondence Address: KENYON & KENYON LLP, ONE BROADWAY, NEW YORK, NY, 10004, US

(21) Appl. No.: 11/258,649

(22) Filed: Oct. 25, 2005

(51) Int. Cl. B01D 39/10

(52) U.S. Cl. 210/499; 210/493.5; 428/221; 428/222; 422/98

(57) ABSTRACT

A wire mesh fabric, having a plurality of wires running in a first parallel direction, the first plurality of wires having a first wire diameter; a second plurality of wires running in a second parallel direction, the second parallel direction orthogonal to the first parallel direction, the second plurality of wires having a second wire diameter; a third plurality of wires running in the second parallel direction, the third plurality of wires interspersed in the second plurality of wires, the third plurality of wires having a third wire diameter, wherein the third wire diameter is greater in diameter than the second wire diameter; and a fourth plurality of wires running in the first parallel direction, the fourth plurality of wires having a fourth wire diameter, wherein the fourth wire diameter is greater in diameter than the first wire diameter.

### FIELD OF THE INVENTION

The present invention relates to wire mesh cloth. More specifically, the present invention provides a wire mesh cloth which has constituent wires with differing diameters.

### BACKGROUND INFORMATION

Wire cloth is used for various functions such as, for example, providing a barrier between different components. Wire cloth is also used to provide a component to strain or separate materials of different sizes.

Wire mesh cloth that is used for straining and/or separating materials is produced with a standardized (common) wire diameter throughout the cloth weave. This standardized diameter for the wire strands comprising the cloth allows the cloth to be manufactured in a uniform manner with minimal cost. This standardized diameter wire cloth, however, has significant drawbacks. The first drawback of standardized diameter wire cloth is that the cloth provides insufficient capacity to resist structural loading which causes degradation. Wire cloth used for filtering, such as in the oil and mining industries, is generally used by inserting the cloth into a frame. The combination of the cloth and the frame are then affixed to a machine, such as a vibratory loading machine. An acceleration is then provided to the cloth and frame combination such that materials placed upon the cloth and frame are either passed through the combination or fall off the side of the combination and removed from further processing. The materials used in the combination of the frame and cloth are sized to prevent degradation from occurring. The combination of the frame and the cloth, however, does not provide the necessary protection to stop ripping of the cloth.

When wire cloth is loaded with materials exiting a feeding apparatus, liquid materials generally pass through the strands of individual wires constituting the cloth. Larger materials, however, either impact the wires in the wire cloth and then pass through the holes between the wires, or the materials impact the individual wires and fail to pass through the open area. When the larger materials either impact the individual wires or impact the wires and fail to pass through the open area, the wires themselves sustain damage. The damage caused by the impact is usually permanent and therefore further damage to the wires may cause individual wires to fail. The structural loading placed upon the wires in the wire cloth is often of a constant force as the continuous process of manufacturing is continued. This constant force is shared over several wires which distribute the loads imparted to the screen. Once an individual wire is severed, the loads carried by that individual wire are then transmitted to adjacent wires. The additional load causes the adjacent wires to deform and similarly fail. This process continues until all the wires in the wire mesh are destroyed from the structural loading placed upon the wire mesh arrangement. To date, there are no structural arrangements of wires which counteract the resulting ripping of wires in a wire mesh arrangement.

There is therefore a need to provide a wire cloth material which can be used to strain and/or separate materials placed upon the cloth.

There is also a need to provide a wire cloth material that provides differing diameters of wire materials used.

There is a further need to provide a wire cloth material which will prevent ripping of the wire cloth material during material loading on the cloth.

There is a further need to provide a wire cloth material which is easy and cost effective to manufacture.

There is a still further need to provide a wire cloth material that can be incorporated into a frame to provide a screen which will segregate material placed upon the frame.

There is a still further need to provide a screen which incorporates a frame and a wire cloth material which will prevent ripping during operation, wherein the screen may be used in equipment commonly used in drilling and mining operations.

### SUMMARY

It is therefore an objective of the present invention to provide a wire cloth material which can be used to strain and/or separate materials placed upon the cloth.

It is also an objective of the present invention to provide a wire cloth material that provides differing diameters of wire materials used.

It is a further objective of the present invention to provide a wire cloth material which will prevent ripping of the wire cloth material during material loading on the cloth.

It is a further objective of the present invention to provide a wire cloth material which is easy and cost effective to manufacture.

It is a further objective of the present invention to provide a wire cloth material that can be incorporated into a frame to provide a screen which will segregate material placed upon the frame.

It is also an objective of the present invention to provide a screen which incorporates a frame and a wire cloth material which will prevent ripping during operation, wherein the screen may be used in equipment commonly used in drilling and mining operations.

The objectives of the present invention are achieved as illustrated and described. The present invention provides a wire mesh fabric, comprising a plurality of wires running in a first parallel direction, the first plurality of wires having a first wire diameter, a second plurality of wires running in a second parallel direction, the second parallel direction orthogonal to the first parallel direction, the second plurality of wires having a second wire diameter, a third plurality of wires running in the second parallel direction, the third plurality of wires interspersed in the second plurality of wires, the third plurality of wires have a third wire diameter, wherein the third wire diameter is greater in diameter than the second wire diameter, and a fourth plurality of wires running in the first parallel direction, the fourth plurality of wires having a fourth wire diameter, wherein the fourth wire diameter is greater in diameter than the first wire diameter.

The present invention also provides for individual embodiments where the first plurality of wires and the second plurality of wires are woven in a plain weave pattern.

The present invention also provides an embodiment wherein the first plurality of wires and the second plurality of wires are woven in a Dutch weave pattern or a twilled pattern.

The present invention also provides a configuration where the first, second and third plurality of wires are made of stainless steel, type 304 stainless steel, plastic, carbon steel or other metal or alloy.

The present invention also provides a material screen for separating a stream of materials into different material sizes. The material screen provides for separating a stream of materials into different material sizes, the screen comprising: a support frame, and a first plurality of wires running in a first parallel direction, the first plurality of wires having a first wire diameter, a second plurality of wires running in a second parallel direction, the second parallel direction orthogonal to the first parallel direction, the second plurality of wires having a second wire diameter, a third plurality of wires running in the second parallel direction, the third plurality of wires interspersed in the second plurality of wires, the third plurality of wires have a third wire diameter, wherein the third wire diameter is greater in diameter than the second wire diameter, and a fourth plurality of wires running the first parallel direction, the fourth plurality of wires interspersed in the first plurality of wires, the fourth plurality of wires having a fourth wire diameter, wherein the fourth wire diameter is greater in diameter than the first wire diameter; wherein the first plurality of wires, the second plurality of wires, the third plurality of wires and the fourth plurality of wires are connected to the frame.

The second embodiment of the present invention also provides that the first plurality of wires and the second plurality of wires are woven in a plain weave pattern, that the first plurality of wires and the second plurality of wires are woven in a Dutch weave pattern or in a twilled pattern.

The second embodiment also provides for the first, second and third plurality of wires to be made of stainless steel, type 304 stainless steel or plastic. The material screen may also be constructed such that the first, second and third plurality of wires each have a different material yield capacity. The material screen may also be configured such that the first, second and third plurality of wires each have a different material yield capacity, wherein the material yield capacity of the third plurality of wires is greater than the material yield capacities of the first and second plurality of wires.

### BRIEF DESCRIPTION OF THE DRAWINGS

FIG. 1 is a top perspective expanded view of a wire mesh arrangement in conformance with present invention.

FIG. 2 is a top perspective view of the wire mesh arrangement according to FIG. 1.

FIG. 3 is a top view of a wire mesh screen in conformance with an exemplary embodiment of the invention.

### DETAILED DESCRIPTION

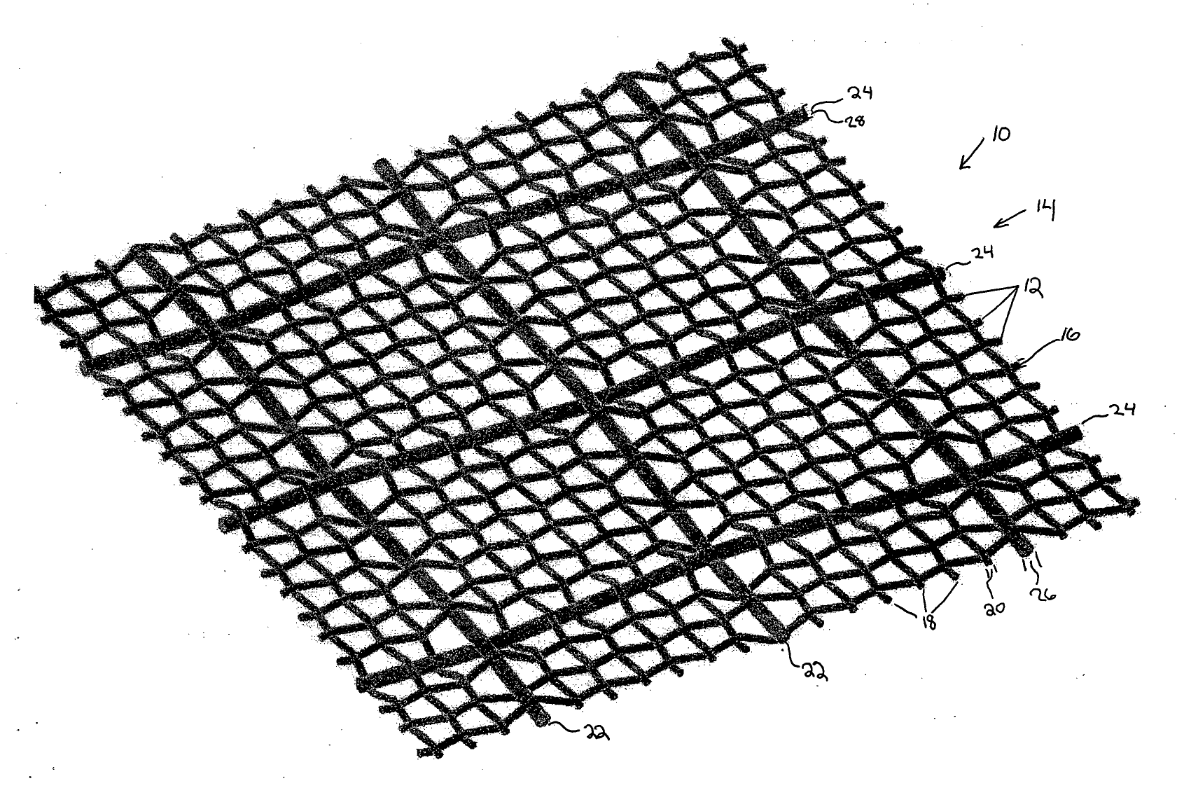

Referring to FIG. 1, a wire mesh cloth 10 is illustrated. The wire mesh cloth 10 has an arrangement of first wires 12 which extend in a horizontal direction 14. The first wires 12 are provided with a first diameter 16. The first diameter 16 is constant throughout all of the arrangement of first wires 12. A second arrangement of wires 18 is also provided with a constant second set of diameters 20. A third arrangement of wires 22 is further provided which are parallel in direction to the arrangement of second arrangement of wires 18. The third arrangement of wires 22 is interspersed in the second arrangement of wires 18 such that the third arrangement of wires 22 extend in a parallel direction to that of the second arrangement of wires 18. A fourth arrangement of wires 24 is also provided in an interspersed manner with the wires of the arrangement of first wires 12. The fourth arrangement of wires 24 extends in a parallel direction to that of the horizontal direction 14 of the arrangement of first wires 12. The third arrangement of wires 22 is formed with a third diameter 26. The fourth arrangement of wires 24 is formed with a fourth diameter 28.

The arrangement of first wires 12, the second arrangement of wires 18, the third arrangement of wires 22 and the fourth arrangement of wires 24 in the illustrated embodiment are constructed from the same material. The materials that can be used to create the wire mesh include stainless steel, type 304 stainless steel, type 316 stainless steel, Kevlar, nylon, bronze, brass, polypropylene, carbon steel and plastic as non-limiting examples. Type 316 stainless steel may also be used such that it includes the addition of 2% molybdenum. In this capacity, the type 316 material has a resistance to pitting corrosion superior to other chromium-nickel stainless steels where brines and chlorides are present. Type 316 also has high creep strength at elevated temperatures compared to other types of materials.

The third arrangement of wires 22 and the fourth arrangement of wires 24 are interspersed within the remainder of the wire mesh cloth 10 to prevent the wire mesh cloth from ripping 10. The third diameters 26 and the fourth diameters 28 of the third arrangement of wires 22 and the fourth arrangement of wires 24 prevent ripping of the wire mesh cloth in the event of a break in the arrangement of first wires 12 and the second arrangement of wires 18.

Although illustrated as being constructed from a single type of material, differing materials may be used to construct each of the individual wires 12, 18, 22, 24. The overall dimensional components of the wire mesh 10 may be varied according to the amount of separation needed for the wire mesh 10. As provided below, standard United States mesh openings ranging from a value of 30 to a value of 400 may be provided according to the dimensions of the wire arrangements used. Major and minor wire diameters can be provided between a minimum and maximum set of values thereby specifying an open area between a corresponding minimum and maximum value. As provided in Table 2, a corresponding mesh count is provided for each of the cloth opening sizes corresponding to minor wire diameter is and major wire diameters. As provided in Table 3, another mesh count as provided for minor wire diameter and major wire of diameters corresponding to the United States mesh counts.

TABLE 1

| Cloth opening | Opening | Minor wire diameter | | Major wire diameter | | Open area | |
|---|---|---|---|---|---|---|---|
| Inches | US Mesh | Max | Min | Max | Min | Max | Min |
| 0.0234 | 30 | 0.02 | 0.0045 | 0.06 | 0.025 | 29.1% | 70.3% |
| 0.0197 | 35 | 0.0162 | 0.004 | 0.0486 | 0.02025 | 30.1% | 69.1% |
| 0.0165 | 40 | 0.013 | 0.0032 | 0.039 | 0.01625 | 31.3% | 70.2% |
| 0.0139 | 45 | 0.011 | 0.0025 | 0.033 | 0.01375 | 31.2% | 71.8% |
| 0.0117 | 50 | 0.0095 | 0.0022 | 0.0285 | 0.01188 | 30.5% | 70.9% |
| 0.0098 | 60 | 0.008 | 0.0019 | 0.024 | 0.01 | 30.3% | 70.2% |
| 0.0083 | 70 | 0.0068 | 0.0016 | 0.0204 | 0.0085 | 30.2% | 70.3% |
| 0.007 | 80 | 0.0056 | 0.0014 | 0.0168 | 0.007 | 30.9% | 69.4% |
| 0.0059 | 100 | 0.0048 | 0.0012 | 0.0144 | 0.006 | 30.4% | 69.1% |
| 0.0049 | 120 | 0.004 | 0.00095 | 0.012 | 0.005 | 30.3% | 70.2% |
| 0.0041 | 140 | 0.0033 | 0.0008 | 0.0099 | 0.00413 | 30.7% | 70.0% |
| 0.0035 | 170 | 0.0028 | 0.00065 | 0.0084 | 0.0035 | 30.9% | 71.1% |
| 0.0029 | 200 | 0.0024 | 0.00055 | 0.0072 | 0.003 | 29.9% | 70.7% |
| 0.0025 | 230 | 0.002 | 0.00055 | 0.006 | 0.0025 | 30.9% | 67.2% |
| 0.0021 | 270 | 0.0017 | 0.00055 | 0.0051 | 0.00213 | 30.5% | 62.8% |
| 0.0017 | 325 | 0.0014 | 0.00055 | 0.0042 | 0.00175 | 30.1% | 57.1% |
| 0.0015 | 400 | 0.0012 | 0.00055 | 0.0036 | 0.0015 | 30.9% | 53.5% |

TABLE 2

| Cloth opening | Opening | Minor wire diameter | | Major wire diameter | | Mesh count (Minor wire) | |
|---|---|---|---|---|---|---|---|
| Inches | US Mesh | Max | Min | Max | Min | Max | Min |
| 0.0234 | 30 | 0.02 | 0.0045 | 0.06 | 0.0250 | 23 | 36 |
| 0.0197 | 35 | 0.0162 | 0.004 | 0.0486 | 0.0203 | 28 | 42 |
| 0.0165 | 40 | 0.013 | 0.0032 | 0.039 | 0.0163 | 34 | 51 |
| 0.0139 | 45 | 0.011 | 0.0025 | 0.033 | 0.0138 | 40 | 61 |
| 0.0117 | 50 | 0.0095 | 0.0022 | 0.0285 | 0.0119 | 47 | 72 |
| 0.0098 | 60 | 0.008 | 0.0019 | 0.024 | 0.0100 | 56 | 85 |
| 0.0083 | 70 | 0.0068 | 0.0016 | 0.0204 | 0.0085 | 66 | 101 |
| 0.007 | 80 | 0.0056 | 0.0014 | 0.0168 | 0.0070 | 79 | 119 |
| 0.0059 | 100 | 0.0048 | 0.0012 | 0.0144 | 0.0060 | 93 | 141 |
| 0.0049 | 120 | 0.004 | 0.00095 | 0.012 | 0.0050 | 112 | 171 |
| 0.0041 | 140 | 0.0033 | 0.0008 | 0.0099 | 0.0041 | 135 | 204 |
| 0.0035 | 170 | 0.0028 | 0.00065 | 0.0084 | 0.0035 | 159 | 241 |
| 0.0029 | 200 | 0.0024 | 0.00055 | 0.0072 | 0.0030 | 189 | 290 |
| 0.0025 | 230 | 0.002 | 0.00055 | 0.006 | 0.0025 | 222 | 328 |
| 0.0021 | 270 | 0.0017 | 0.00055 | 0.0051 | 0.0021 | 263 | 377 |
| 0.0017 | 325 | 0.0014 | 0.00055 | 0.0042 | 0.0018 | 323 | 444 |
| 0.0015 | 400 | 0.0012 | 0.00055 | 0.0036 | 0.0015 | 370 | 488 |

TABLE 3

| Cloth opening | Opening | Minor wire diameter | | Major wire diameter | | Mesh count (Minor wire) | |
|---|---|---|---|---|---|---|---|
| Inches | US Mesh | Max | Min | Max | Min | Max | Min |
| 0.0234 | 30 | 0.02 | 0.0045 | 0.06 | 0.0250 | 5 | 0.4 |
| 0.0197 | 35 | 0.0162 | 0.004 | 0.0486 | 0.0203 | 6 | 0.4 |
| 0.0165 | 40 | 0.013 | 0.0032 | 0.039 | 0.0163 | 7 | 0.5 |
| 0.0139 | 45 | 0.011 | 0.0025 | 0.033 | 0.0138 | 8 | 0.6 |
| 0.0117 | 50 | 0.0095 | 0.0022 | 0.0285 | 0.0119 | 9 | 0.7 |
| 0.0098 | 60 | 0.008 | 0.0019 | 0.024 | 0.0100 | 11 | 0.9 |
| 0.0083 | 70 | 0.0068 | 0.0016 | 0.0204 | 0.0085 | 13 | 1.0 |
| 0.007 | 80 | 0.0056 | 0.0014 | 0.0168 | 0.0070 | 16 | 1.2 |
| 0.0059 | 100 | 0.0048 | 0.0012 | 0.0144 | 0.0060 | 19 | 1.4 |
| 0.0049 | 120 | 0.004 | 0.00095 | 0.012 | 0.0050 | 22 | 1.7 |
| 0.0041 | 140 | 0.0033 | 0.0008 | 0.0099 | 0.0041 | 27 | 2.0 |
| 0.0035 | 170 | 0.0028 | 0.00065 | 0.0084 | 0.0035 | 32 | 2.4 |
| 0.0029 | 200 | 0.0024 | 0.00055 | 0.0072 | 0.0030 | 38 | 2.9 |
| 0.0025 | 230 | 0.002 | 0.00055 | 0.006 | 0.0025 | 44 | 3.3 |
| 0.0021 | 270 | 0.0017 | 0.00055 | 0.0051 | 0.0021 | 53 | 3.8 |
| 0.0017 | 325 | 0.0014 | 0.00055 | 0.0042 | 0.0018 | 65 | 4.4 |
| 0.0015 | 400 | 0.0012 | 0.00055 | 0.0036 | 0.0015 | 74 | 4.9 |

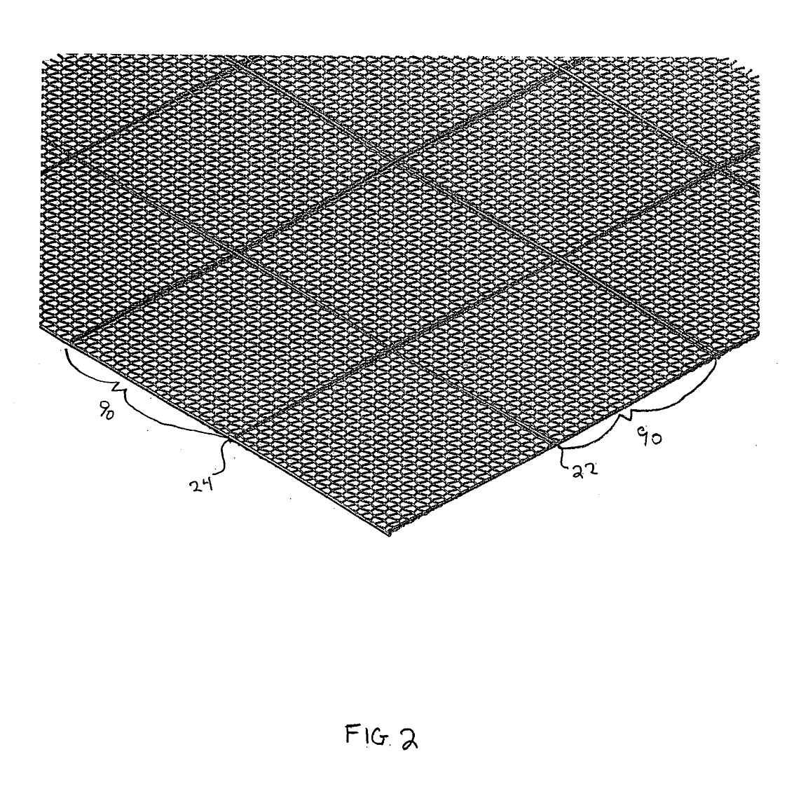

Referring to FIG. 2, an expanded view of the wire mesh fabric 10 of the present invention is illustrated. The spacing 90 of the third arrangement of wires 22 and the fourth arrangement of wires 24 may be modified to provide lesser or greater amounts of rip stop potential. To increase the amount of rip stop potential of the wire mesh fabric 10, the spacing of the third arrangement of wires 22 and the fourth arrangement of wires 24 is decreased in dimension, thereby allowing more wire material per planar area to be incorporated within the wire mesh fabric 10. To decrease the amount of rip stop potential, the spacing of the third arrangement of wires 22 and the fourth arrangement of wires 24 is increased thereby decreasing the amount of wire material per planar area incorporated within the wire mesh cloth 10. Additionally, to increase the amount of rip stop potential of the wire mesh fabric 10 the materials of either the third arrangement of wires 22 and\or the fourth arrangement of wires 24 may be chosen such that the materials for these individual wire arrangements do not degrade under the anticipated structural loading conditions.

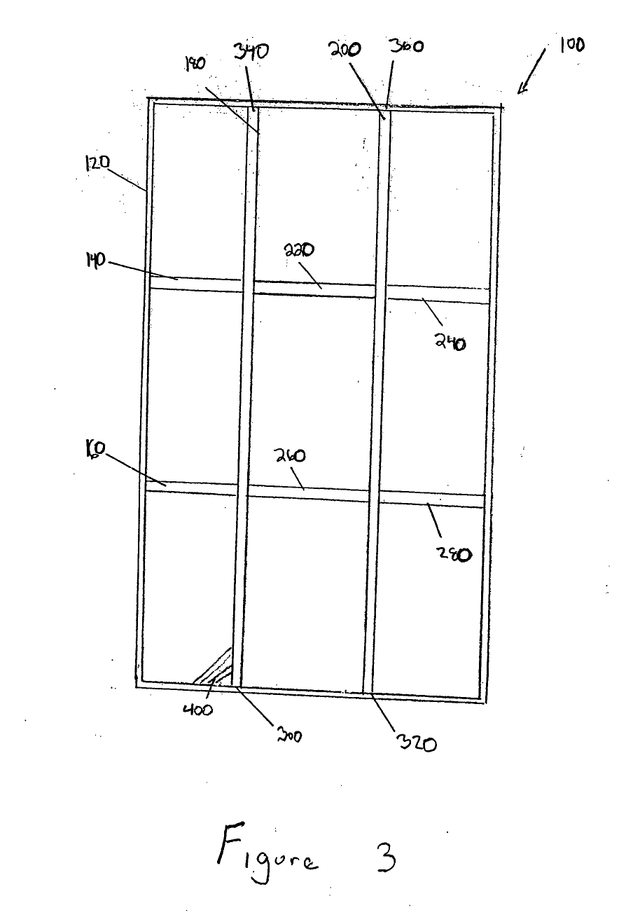

Referring to FIG. 3, a vibratory screen 100 is illustrated. The vibratory screen 100 is configured from a frame 120 which extends around the periphery of the vibratory screen 100. The frame can be broken into sections to allow for additional support of material such as wire mesh cloth 400 placed on the screen 100. The wire mesh screen 400 displaced across the entire vibratory screen 100 to allow for separation of materials placed upon the screen 100. In the illustrated embodiment provided in FIG. 3, a first member 180 is connected to the remainder of the frame 120 at a first point 340 and a second point 300. In a similar configuration, the second member 200 is connected to the remainder of the frame 120 at a first connection 360 and a second connection 320. The first member 180 and the second member 200 extend along the entire length of the frame. In an effort to reduce the amount of deflection in the first member 180 and second member 200, a first section of supports 140, 220, 240 are provided at an approximate one third distance along the entire length of the first member 180 and second member 200. In a likewise configuration, a second section of supports 160, 260, 280 is provided at an approximately two-thirds length down the first member 180 and second member 200. The connection between the first member 180 and second member 200 and the first section of supports 140, 220, 240 as well as the second section of supports 160, 260, 280 is through a welded connection.

In the illustrated embodiment, the frame 120 is made of tubular steel. The tubular steel is designed to have a thickness which will limit the overall deflection of the vibratory screen 100 during all structural loading conditions. The supports are all coated with a coating which will limit or eliminate the amount of corrosion on the individual support members. A non limiting example of the coating includes Polyamide Epoxy such as Epolon II Rust Inhibitive Epoxy Primer and finish coat by Sherwin Williams Company as well as acrylic and polyurethane systems.

The present invention provides many advantages which are significant in the field of wire mesh cloth. The present invention provides a wire mesh cloth which has differing diameters of wire strands which create the overall wire mesh matrix. The differing diameter sizes of the individual wire mesh allow the wire mesh arrangement to withstand structural loading placed upon the entire matrix. A particular advantage of the present invention is that the placement of larger diameter wires in the wire mesh arrangement prevents the ripping of individual wire strands when a failure of an individual strand occurs. This heretofore unknown feature prevents wire mesh screen arrangements from disintegrating in a catastrophic manner thereby protecting the safety of individuals and equipment. The degradation mechanisms of the wires may then be more accurately calculated (through the process of erosion and corrosion) allowing the owner of the wire mesh arrangement to predict when failure will occur. This in turn increases the economic viability of using wire mesh arrangements of this configuration because maintenance schedules for repair of wire mesh arrangements can be planned.

Although illustrated in a classical weave configuration, other types of leaves may be used in the construction of the wire mesh arrangement. Exemplary embodiments include Dutch weaves, and twill weaves, as non limiting embodiments.

The present invention may also include differing types of frames upon which the wire mesh may be position. The frames can vary in the overall size such that the wire mesh can be installed upon machines, such as a vibratory loading machines for use in oil and mining operations. The frame can be comprised of individual tubes or structural elements welded to form the overall frame upon which the wire mesh is attached. The wire mesh may be attached to the frame through the use of epoxy or other materials. Wire mesh can be included directly onto the frame in a single layer or, in another exemplary embodiment, provided in a three part system as a non limiting example. The stacking of the individual layers of wire mesh can effectively reduce the amount of open area present in the wire mesh arrangement.

The present invention can also allow the individual wire strands to be made of differing material and therefore take advantage of the different material properties of the wires. The present invention can be used in segregation of materials such as in the pharmaceutical field, food, mining and industrial processing and home use, such as window screening. The present invention also can be produced such that a single wire strand is conductive to electricity with the other wires non-conductive. The single wire strand can then be monitored for amperage or voltage during operation of the wire mesh. Changes in amperage or voltage due to degradation of the wire can then indicate the overall condition of the wires in the wire mesh arrangement. Alternatively, several wires which do not connect with one another can be used throughout the cloth to provide and indication of the overall remaining capacity of the wire mesh cloth.

In the foregoing specification, the invention has been described with reference to specific exemplary embodiments thereof. It will, however, be evident that various modifications and changes may be made thereunto without departing from the broader spirit and scope of the invention as set forth in the appended claims. The specification and drawings are accordingly to be regarded in an illustrative rather than in a restrictive sense.

What is claimed is:

1. A wire mesh fabric, comprising
a first plurality of wires running in a first parallel direction, the first plurality of wires having a first wire diameter;
a second plurality of wires running in a second parallel direction, the second parallel direction orthogonal to the first parallel direction, the second plurality of wires having a second wire diameter;
a third plurality of wires running in the second parallel direction, the third plurality of wires interspersed in the second plurality of wires, the third plurality of wires having a third wire diameter, wherein the third wire diameter is greater in diameter than the second wire diameter; and
a fourth plurality of wires running in the first parallel direction, the fourth plurality of wires having a fourth wire diameter, wherein the fourth wire diameter is greater in diameter than the first wire diameter.

2. The wire mesh fabric according to claim 1, wherein first plurality of wires and the second plurality of wires are woven in a plain weave pattern.

3. The wire mesh fabric according to claim 1, wherein the first plurality of wires and the second plurality of wires are woven in a Dutch weave pattern.

4. The wire mesh fabric according to claim 1, wherein the first plurality of wires and the second plurality of wires are woven in a twilled pattern.

5. The wire mesh fabric according to claim 1, wherein the first, second and third plurality of wires are made of stainless steel.

6. The wire mesh fabric according to claim 1, wherein the first, second and third plurality of wires are made of type 304 stainless steel.

7. The wire mesh fabric according to claim 1, wherein the first, second and third plurality of wires are made of plastic.

8. The wire mesh fabric according to claim 1, wherein the first, second and third plurality of wires each have a different material yield capacity.

9. The wire mesh fabric according to claim 1, wherein the first, second and third plurality of wires each have a different material yield capacity, wherein the material yield capacity of the third plurality of wires is greater than the material yield capacities of the first and second plurality of wires.

10. A material screen for separating a stream of materials into different material sizes, comprising:
a support frame, and
a first plurality of wires running in a first parallel direction, the first plurality of wires having a first wire diameter;
a second plurality of wires running in a second parallel direction, the second parallel direction orthogonal to the first parallel direction, the second plurality of wires having a second wire diameter;
a third plurality of wires running in the second parallel direction, the third plurality of wires interspersed in the second plurality of wires, the third plurality of wires having a third wire diameter, wherein the third wire diameter is greater in diameter than the second wire diameter; and
a fourth plurality of wires running the first parallel direction, the fourth plurality of wires interspersed in the first plurality of wires, the fourth plurality of wires having a fourth wire diameter, wherein the fourth wire diameter is greater in diameter than the first wire diameter; wherein the first plurality of wires, the second plurality of wires, the third plurality of wires and the fourth plurality of wires are connected to the frame.

11. The material screen according to claim 10, wherein first plurality of wires and the second plurality of wires are woven in a plain weave pattern.

12. The material screen according to claim 10, wherein the first plurality of wires and the second plurality of wires are woven in a Dutch weave pattern.

13. The material screen according to claim 10, wherein the first plurality of wires and the second plurality of wires are woven in a twilled pattern.

14. The material screen according to claim 10, wherein the first, second, third and fourth plurality of wires are made of stainless steel.

15. The material screen according to claim 10, wherein the first, second, third and fourth plurality of wires are made of type 304 stainless steel.

16. The material screen according to claim 10, wherein the first, second, third and fourth plurality of wires are made of plastic.

17. The material screen according to claim 10, wherein the first, second, third and fourth plurality of wires each have a different material yield capacity.

18. The material screen according to claim 10, wherein the first, second, third and fourth plurality of wires each have a different material yield capacity, wherein the material yield capacity of the third plurality of wires is greater than the material yield capacities of the first and second plurality of wires.

19. The material screen according to claim 10, wherein the frame is made of stainless steel.

20. The material screen according to claim 10, wherein the frame is made in a corrugated shape.

21. The material screen according to claim 10, wherein the frame is made is a flat shape.

22. The material screen according to claim 10, wherein the frame is made with a channel of a bottom face of the frame, the channel having a sealing arrangement for sealing the frame to a machine.

23. The material screen according to claim 10, wherein the frame is coated with epoxy.
